(19) United States
(12) Patent Application Publication
(10) Pub. No.: US 2008/0032816 A1
(43) Pub. Date: Feb. 7, 2008

(54) GOLF CLUB WITH UNIFORM FACE THICKNESS

(76) Inventor: Terrill R. McCabe, Carlsbad, CA (US)

Correspondence Address: OSTROLENK FABER GERB & SOFFEN, 1180 AVENUE OF THE AMERICAS, NEW YORK, NY, 100368403, US

(21) Appl. No.: 11/869,315

(22) Filed: Oct. 9, 2007

Related U.S. Application Data
(62) Division of application No. 11/330,451, filed on Jan. 12, 2006.
(60) Provisional application No. 60/644,261, filed on Jan. 14, 2005.

(51) Int. Cl. A63B 53/04; B23C 3/00

(52) U.S. Cl. 473/340; 29/56.5

(57) ABSTRACT

According to one embodiment, a putter head comprises a face with a striking surface having a predetermined angular loft and a pocket positioned behind the striking surface, and including a back wall adjacent to the striking surface and oriented in a first direction and at least four flanges protruding from the back wall in a second direction differing from the first direction, wherein the back wall is substantially in parallel with the striking surface.

### CROSS-REFERENCE TO RELATED APPLICATION

The present application is a divisional of U.S. patent application Ser. No. 11/330/451, filed Jan. 12, 2006, and claims the benefit and priority of U.S. Provisional Application No. 60/644,261, filed Jan. 14, 2005 and entitled GOLF CLUB WITH UNIFORM FACE THICKNESS, the entire disclosure of which are incorporated by reference herein.

### BACKGROUND

1. Field of the Invention

Embodiments of the present invention relate to the field of golf equipment. More specifically, one embodiment of the invention relates to a golf club head, particularly a putter head, adapted with a face which is substantially uniform in thickness and relates to a method of producing the golf club head.

2. Related Art

For decades, a common adage has been repeated by golfers and golfing fans alike—“drive for show, putt for dough.” This adage represents a common understanding by the golfing community that putting is one of the most critical parts in the game of golf. Putting involves the use of a specialized club, referred to as a “putter,” which is normally used by a golfer when his ball is resting upon a putting green. Typically, a putter features a putter head with a face portion having a generally flat surface for striking the ball and a shaft that extends upward from the putter head. The design of the putter head not only facilitates controlled movement of the golf ball, but also provides sensory feedback to the golfer.

In putting, a golfer relies on three of his five senses: sight, feel and sound. It is well established that the “sound” of the putter head making contact with the golf ball provides a golfer with a substantial amount of feedback information, which consciously and subconsciously assists him when hitting putts in the future. For example, the sound of impact improves the golfer's awareness as to whether the putter face made proper impact with the golf ball (e.g., impact at the sweet-spot on the putter face). This sound in combination with “feel,” which is a collection of sensory observations by the golfer during a putt (e.g., detected amount of vibration at impact, estimated velocity of his putting stroke, etc.), constitute feedback information that can be used by the golfer to judge how hard to hit the golf ball for future putts at varying distances. In fact, “sound” is so closely related to “feel” that, in many cases, “sound” is an important factor of “feel”.

For putters, it is desirable for the sound of a putter face impacting the ball at the sweet spot to differ from the sound of an off-center impact. The “sweet spot” of the putter face is the point on the face where there is no torque or twisting (vertically and/or horizontally) of the putter. This is the optimal location of impact because it does not cause any unwanted angular rotation of the golf ball, unlike an off-center impact. Besides loss of direction, an off-center impact causes a loss of distance.

Currently, to amplify the sound of impact and provide greater feel, many putter heads, such as putter head 100 as shown in FIG. 1, are produced with a recessed cavity 110 behind a face 120. One problem associated with putter head 100 is that the thickness of face 120, namely the distance between a ball-striking surface 130 and a back wall 140 of cavity 110, is commonly tapered and non-uniform. As shown, when ball-striking surface 130 is created with positive loft, face 120 has a greater thickness toward a bottom flange 112 of cavity 110 than a top flange 114 of cavity 110. For instance, the measured thickness T1 is less than the measured thickness T2, which is less than the measured thickness T3. This poses a number of problems.

One problem relates to the lack of audible distinction between impact at the sweet-spot of the putter head and an off-center impact. For instance, when hitting a fifty-foot putt, golfers tend to stroke the putter so that the point of impact is off-center and low (toward a bottom edge 150 of putter head 100). Unfortunately, due to its tapered and non-uniform thickness, face 120 does not distinctively resonate between an off-center, low impact and a “sweet spot” impact. This lack of sound separation does not fully provide a sufficient level of feedback data that golfer's normally obtain from impact sounds.

Another problem is that the tapered, non-uniform thickness of face 120 tends to cause substantial differences in rebound speed of the golf ball after impact. For instance, with conventional putter head 100, the rebound speed of the golf ball is greatly influenced by the vertical location of impact on the face 120. This lack of consistency increases the difficulty for a golfer to find the proper stroke velocity for putts at different distances.

It is noted that cavity 110 is tapered and non-uniform in thickness because, as shown in FIG. 2, both a cutting end 210 and a cutting edge 220 of conventional end mills 200, typically used to cut cavity 110 of FIG. 1, possess the same outer diameter thickness. Thus, as shown in FIG. 3, according to current methods of manufacture, the presence of top and bottom flanges 112 and 114 precludes back wall 140 from being cut in parallel with ball-striking surface 130 of FIG. 1.

### SUMMARY

A putter head in accordance with an embodiment of the present application includes a face with a striking surface with a predetermined angular loft and a pocket positioned behind the striking surface, wherein the pocket is formed by a back wall that is adjacent to the striking surface and extends in a first direction, and at least four flanges that protrude from the back wall in a second direction, differing from the first direction, wherein the back wall is substantially parallel to the striking surface.

A method for manufacturing a putter head including a face with a striking surface that has a loft of a predetermined angle and a pocket formed behind the face defined by a back wall positioned adjacent to the striking surface extending in a first direction and at least four flanges extending from the back wall in a second direction, different from the first direction in accordance with an embodiment of the present application includes positioning the putter head in a predetermined position and altering the pocket of the putter head so that the back wall is substantially parallel to the striking surface.

An end mill for altering a pocket of a golf club head including a striking surface having a predetermined loft angle according to an embodiment of the present application includes a shank and a cutter coupled to a first end of the shank and adapted to remove material from the pocket of the golf club head positioned behind the striking surface, wherein the cutter includes a plurality of cutting surfaces including an end-cutting surface and a side-cutting surface positioned around the perimeter of the end-cutting surface, the side-cutting surface being tapered with an angle at least equal to the predetermined loft angle.

An end mill for altering a pocket of a golf club head including a striking surface having a predetermined loft angle according to another embodiment of the present application includes a cutting end positioned on a first end of the end mill and a cutting edge tapered at an angle at least equal to the predetermined angle from the first end back to a second end, wherein the end mill accesses areas adjacent to both a back wall and a top or bottom flange of the pocket of the golf club head.

### BRIEF DESCRIPTION OF THE DRAWINGS

The features and advantages of the present invention will become apparent from the following detailed description of the present invention in which:

FIG. 1 is a cross-sectional view of a conventional putter head having a tapered, substantially non-uniform face.

FIG. 2 is an illustration of a conventional end mill for use in cutting a pocket in the putter head of FIG. 1;

FIG. 3 is a cross-sectional view of a conventional end mill of FIG. 2 in use to cut the cavity according to conventional methods of manufacture.

FIG. 4 is a perspective view of a first exemplary embodiment of a putter having a face pocket and adapted in accordance with the invention.

FIG. 5 is a cross-sectional view of the putter head of FIG. 4 adapted with a face having a substantially uniform thickness.

FIG. 6 is a cross-sectional view of the putter head of FIG. 5 adapted with a slot oriented with an offset angle substantially equivalent to the angular orientation of the back wall and striking surface of the face.

FIG. 7 is a cross-sectional view of the putter head of FIG. 5 adapted with an angular oriented slot positioned against the back wall of the face.

FIG. 8 is a cross-sectional view of the putter head of FIG. 5 adapted with at least two slots of which at least one slot is oriented with the offset angle.

FIG. 9 is a cross-sectional view of the putter head similar to FIG. 4 with a face having a substantially uniform thickness and a striking surface having a negative loft.

FIG. 10 is a cross-sectional view of the putter head of FIG. 9 adapted with an angular oriented slot matching the angular orientation of the back wall and striking surface of the face.

FIG. 11 is a first exemplary embodiment of an end mill for manufacturing the putter head of FIG. 5.

FIGS. 12-14 illustrate an exemplary embodiment of a process for manufacturing the putter head of FIG. 5 utilizing the end mill of FIG. 11.

FIGS. 15A-15C are second exemplary embodiments of an end mill for post-processing the putter head of FIG. 5.

FIG. 16-19 illustrate an exemplary embodiment of post-processing operations for manufacturing the putter head of FIG. 5 utilizing the end mill of FIG. 15A.

FIG. 20 is an exemplary embodiment of a flowchart illustrating the process of manufacture of a putter head including a face of a substantially uniform thickness.

FIG. 21 is an exploded view of a second exemplary embodiment of a putter.

FIG. 22 is a cross-sectional view of the putter head of FIG. 21 adapted with a face having a substantially uniform thickness.

FIG. 23 is a perspective view of the back side of the putter of FIG. 21.

### DETAILED DESCRIPTION

Herein, exemplary embodiments of the invention relate to a golf club head, particularly a putter head, adapted with a face that is substantially uniform in thickness and a method of producing the putter head. The putter head may be produced through Computer Numeric Controlled (CNC) milling, hand milling or any other type of milling technique. As an alternative, however, the putter head may be produced through electrical discharge milling (EDM).

### A. First Embodiment

### A Positive-Loft Putter Head

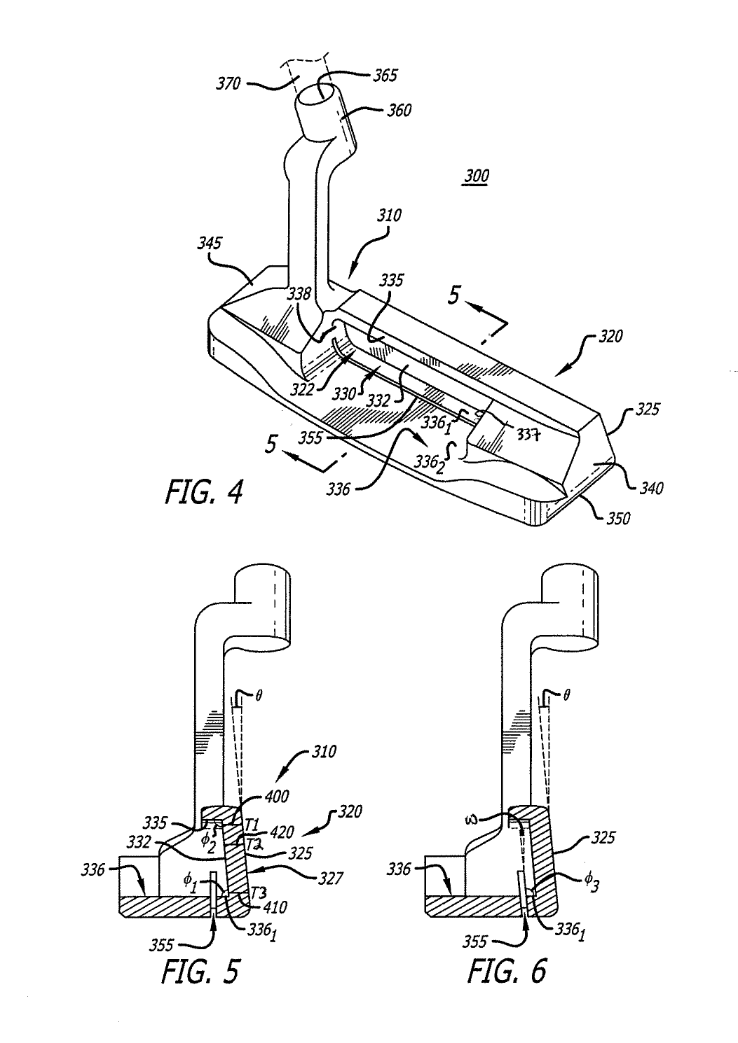

Referring to FIG. 4, a perspective view of a first exemplary embodiment of a putter 300 is shown. Putter 300 includes a putter head 310 and an optional elevated hosel 360 extending upward and having an opening 365 into which one end of a shaft 370 is inserted. The other end of shaft 370 is equipped with a grip (not shown) that is held by the golfer during use. Of course, it is contemplated that putter head 310 may not be adapted with hosel 360. Instead, a top surface of putter head 310 would feature an opening sized to directly receive an end of shaft 370.

According to one embodiment of the invention, putter head 310 is generally formed from a homogenous or single piece of material (e.g., a metal or a composition of metal) and includes a face 320 with a recessed cavity (referred to as a “pocket”) 330 partially formed into a back area 322 of face 320.

Face 320 includes a striking surface 325 with rounded corners proximate to a toe 340 and a heel 345 of putter head 310. Typically, striking surface 325 is substantially flat, but may be considered with a slight curvature for some styles of putter heads.

Pocket 330 is partially formed into back area 322 of face 320, namely back wall 332 of pocket 330 is positioned adjacent to striking surface 325. As shown, pocket 330 is a recessed cavity with back wall 332 bordered by at least four surfaces. According to this embodiment of the invention, pocket 330 features a top flange 335, a bottom flange 336 and side flanges 337 and 338 bordering and protruding from back wall 332. Bottom flange 336 protrudes a greater distance from back wall 332 than top flange 335.

As an optional feature, a surface of putter head 310 that comes into contact with the grass, referred to as the “sole 350,” is rounded with a predetermined radius to provide a negative bounce angle. The bounce angle may range from zero degrees up to two degrees or more. Sole 350 typically features the bounce angle so that the likelihood of the trailing end of sole 350, namely a portion of sole 350 below pocket 330, catching the grass during a putting stroke is mitigated.

As yet another optional feature, one or more slots 355 may be cut upwardly through sole 350 in order to enhance vibration of face 320 to a perceivable audible frequency at impact with a golf ball. According to one embodiment of the invention, slot 355 is cut into bottom flange 336, which produces a pre-slot (inner) flange portion 336₁ and a post-slot (outer) flange portion 336₂. The width of slot 355 ranges from approximately one one-hundredth of an inch up to one-eighth of an inch. Slot 355 may be positioned up to one-half of an inch from a back wall 332 of pocket 330.

As described below in detail, slot 355 may be made substantially perpendicular to an interior surface of flange 336. Alternatively, slot 355 may be provided with an angular orientation (offset angle from vertical) substantially equivalent to the angular orientation of striking surface 325 from vertical (hereinafter referred to as “loft” and represented by “θ”).

Referring now to FIG. 5, a cross-sectional view along line 5-5 of putter head 310 (FIG. 4) adapted with face 320 having a substantially uniform thickness is shown. According to this embodiment of the invention, striking surface 325 is adapted with a loft (θ) ranging anywhere up to five degrees or more, depending on the golfer's preference. Normally, the loft (θ) ranges between one-half degree (0.5°) and five (5°) degrees (e.g., 0.5°<θ<5°), however, the loft may be any desired amount. As illustrated, striking surface 325 features a positive loft (backward slant) of approximately four degrees (θ≈4°), although it is contemplated that striking surface 325 may be adapted with a negative loft (forward slant) in lieu of a positive loft as shown in FIGS. 9-10, for example.

As further illustrated in FIG. 5, for this embodiment of the invention, back wall 332 is adapted with substantially the same angular orientation as striking surface 325. In other words, back wall 332 has the same predetermined loft as striking surface 325. This places back wall 332 substantially in parallel with striking surface 325. As a result, the thickness of face 320, namely the width between striking surface 325 and back wall 332, is substantially uniform. In other words, a thickness (T1) 400 of face 320 proximate to top flange 335 is substantially equivalent to a thickness (T3) 410 of face 320 proximate to bottom flange 336 as well as the thickness (T2) 420 measured at any point along back wall 332 and its corresponding point on striking surface 325.

In addition, an interior angle (Φ₁) between back wall 332 and an interior surface of pre-slot bottom flange portion 336₁ is the complementary angle to the loft (Φ₁=|90°−θ|). As a result, according to one embodiment of the invention, the interior angle (Φ₁) ranges anywhere between 85° and 89.5°. According to one embodiment of the invention, an interior surface (Φ₂) associated with top flange 335 is the summation of the loft and an angle normal to back wall 332 producing an interior obtuse angle (Φ₂=|θ+90°|). As a result, according to this embodiment, the obtuse interior angle would range anywhere between 90.5° and 95°. Of course, as an alternative, it is contemplated that interior surface (Φ₂) may be adapted to be substantially normal (≈90°) to back wall 332.

As a result, face 320 with substantially uniform thickness is adapted to consistently resonate at distinct audible frequencies between an off-center impact and a “sweet spot” impact. The “sweet-spot” impact is an impact on a point on striking surface 325 (referred to as “sweet spot” 327) where no torque or twisting of the putter occurs. Moreover, besides enhancing the audible frequency at impact with a golf ball, face 320 with substantially uniform thickness provides a more consistent rebound speed regardless of the vertical point of impact.

It is contemplated that the audible frequency produced by face 320 upon impact with a golf ball may be altered by varying thickness 400 of face 320 or by varying the volume of pocket 330. The volume of pocket 330 can be varied through modification of its aspect ratio, namely modification of its length and/or width and/or depth of pocket 310. Such alterations may be conducted in order to further enhance sound separation between an impact at sweet-spot 327 of striking surface 325 and an off-center impact.

In addition, alteration of slot 355 separately or in combination with alteration of face 320 and/or pocket 330 may further enhance such sound separation. For instance, changes in the location of slot 355 in relationship to back wall 332, the number of slots, or the width of the slot(s) may modify and distinguish the audible frequency at certain points of impact.

As shown in detail in FIG. 5, slot 355 may be made substantially perpendicular to an interior surface of flange 336 as described. Alternatively, as shown in FIG. 6, slot 355 may be made at an offset angle (Ω) from vertical, where the offset angle (Ω) is substantially equivalent to the loft (θ) of striking surface 325.

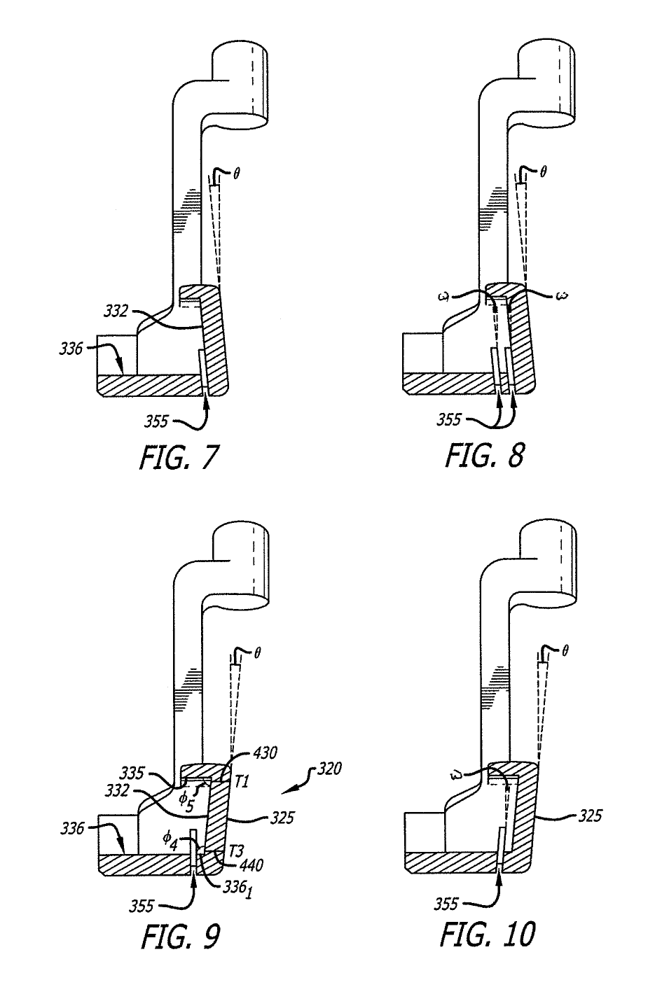

As a result, for a putter with striking surface 325 having a positive loft, an interior angle (Φ₃) between an interior surface of pre-slot flange portion 336₁ and a plane encompassing the angled slot 355 is an interior obtuse angle (Φ₃=|90°+Ω|). As a result, according to one embodiment of the invention, the interior angle (Φ₃) ranges anywhere between 90.5° and 95°. Of course, it is contemplated that angled slot 355 may be made into bottom flange 336 and positioned to abut against back wall 332 as shown in FIG. 7. Also, two or more slots 355 may be implemented, where at least one and perhaps both slots 355 are angled with offset angle (Ω) substantially equivalent to the loft (θ) as shown in FIG. 8. In addition, multiple slots 355 may be provided in the bottom flange 336 such that they are substantially perpendicular to the interior surface of the flange 336, if desired.

### B. Second Embodiment

### A Negative-Loft Putter Head

Referring to FIG. 9, a cross-sectional view of a putter head adapted with a face substantially uniform in thickness and with striking surface 325 having a negative loft (forward slant) is shown. According to this embodiment of the invention, the reference numerals used are equivalent to those set forth in FIG. 5 described above.

Herein, striking surface 325 is adapted with a negative loft (θ) ranging anywhere up to minus five degrees or more. For example, the loft (θ) may range between −0.5° and −5°, depending on the golfer's preference. As illustrated, striking surface 325 features a negative loft (e.g., θ≈−4°) with back wall 332 adapted with substantially the same predetermined loft as striking surface 325. As a result, back wall 332 is substantially in parallel with striking surface 325, and thus, the thickness of face 320, namely the width between striking surface 325 and back wall 332, is substantially uniform. As shown, a thickness (T1) 430 of face 320 proximate to top flange 335 is substantially equivalent to a thickness (T3) 440 of face 320 proximate to bottom flange 336 as well as any thickness measured between these two points.

In addition, an interior angle (Φ₄) between an interior surface of pre-slot flange portion 336₁ and back wall 332 is an obtuse angle (Φ₄=|−90°+θ|). As a result, according to one embodiment of the invention, the interior angle (Φ₄) ranges anywhere between 90.5° and 95°. According to one embodiment of the invention, an interior surface (Φ₅) associated with top flange 335 is a complementary angle of the loft (Φ₅=|−90°−θ|). As a result, according to this embodiment, the interior angle (Φ₅) would range anywhere between 85° and 89.5°. Of course, as an alternative, it is contemplated that interior surface (Φ₄) may be adapted to be substantially normal to back wall 332.

As shown, slot 355 may be made substantially perpendicular to an interior surface of bottom flange 336 as shown. Alternatively, as shown in FIG. 10, slot 355 may be made at an offset angle (Ω), which is substantially equivalent to the negative loft (θ) of striking surface 325.

### C. End Mill Embodiment & General Manufacturing Operations

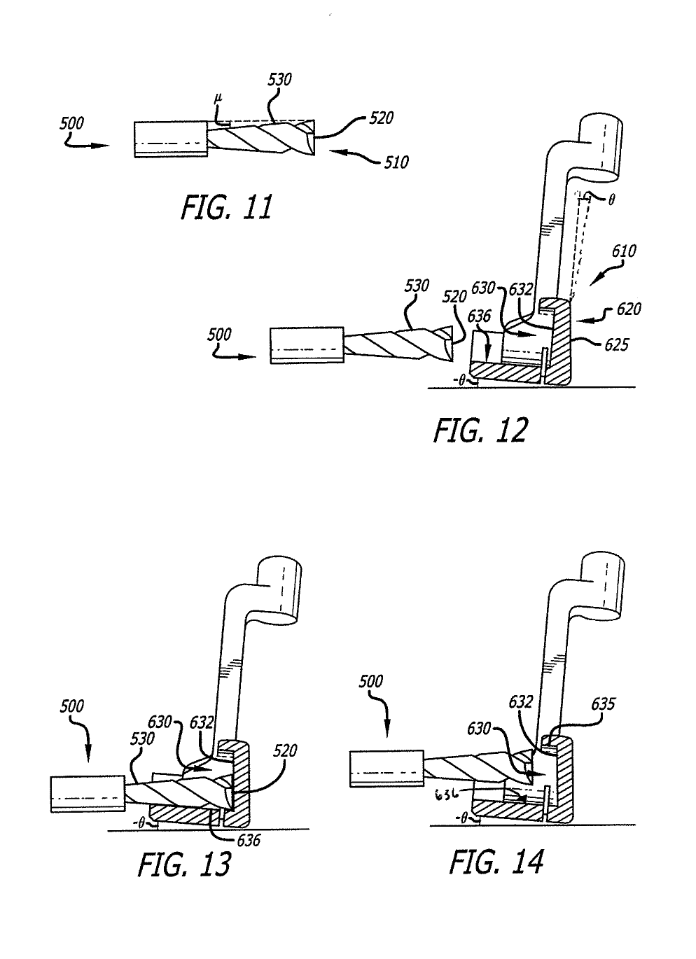

Referring now to FIG. 11, a first exemplary embodiment of an end mill 500 for manufacturing a putter head 310 such as that illustrated in FIGS. 4-5 is shown. End mill 500 includes a reverse tapered cutter 510 that is adapted to cut at a cutting end 520 and along a reverse tapered cutting edge 530. The reverse tapered shape of cutting edge 530 enables cutter 510 to access areas adjacent to both the back wall and the top or bottom flanges within the pocket of the putter head.

Tapered cutting edge 530 is tapered at an angle (μ), which is an angle at least equal to the loft angle (θ) of striking surface 325 of the putter head with a positive loft angle as shown in FIG. 5 (e.g., μ≧θ). Where the loft angle (θ) is a negative angle, the tapered angle (μ) of cutting edge 530 would still need to be equal to or greater than the absolute value of the loft angle (μ≧|θ|).

FIGS. 12-14 illustrate an exemplary embodiment of a process for manufacturing a putter head 610 similar to putter head 310 shown in FIGS. 4 and 5 using end mill 500 of FIG. 11. According to this embodiment of the invention, putter head 610 is initially formed to create a face 620 having a non-uniform thickness and a striking surface 625 having a predetermined degree of loft (e.g., again using θ≈4°). According to one embodiment, putter head 610 is vertically rotated by an angle (−θ) to square striking surface 625 so that, in this position, striking surface 625 has no loft. That is, the striking surface is substantially perpendicular to the ground or a horizontal plane. Of course, in lieu of rotating putter head 610, it is contemplated that end mill 500 may be vertically rotated by the angle (−θ) during milling operations, provided putter head 610 is not rotated.

As shown in FIGS. 12 and 13, according to this embodiment of the invention, end mill 500 is used to mill pocket 630 of putter head 610. End mill 500 is positioned to move in a generally horizontal direction toward pocket 630 with reverse tapered cutting edge 530 guided along an interior top surface of bottom flange 636. Upon insertion into pocket 630, cutting end 520 cuts back wall 632 while reverse tapered cutting edge 530, tapered by angle μ, accesses and removes any material adjacent to both back wall 632 and bottom flange 636 of pocket 630. The result of both cutting operations is to provide a vertically planar back wall 632 so that face 620 possesses a substantially uniform thickness.

Referring to FIG. 14, end mill 500 is moved upward to remove material adjacent to both back wall 632 and top flange 635 of pocket 630. Upon completion, end mill 500 is removed in a generally horizontal direction opposite the direction of insertion into pocket 630 to provide a radial edge or is removed at an angle (−μ) from horizontal to cut top flange 635 so that an inner surface of top flange 635 is substantially in parallel with an interior surface of bottom flange 636. Similarly, end mill 500 may be angularly adjusted to prevent the side flanges (e.g., flanges 337 and 338 of FIG. 4) from having radial interior surfaces, but instead, are substantially planar and in parallel to each other.

### D. General Post-Processing Manufacturing Operations

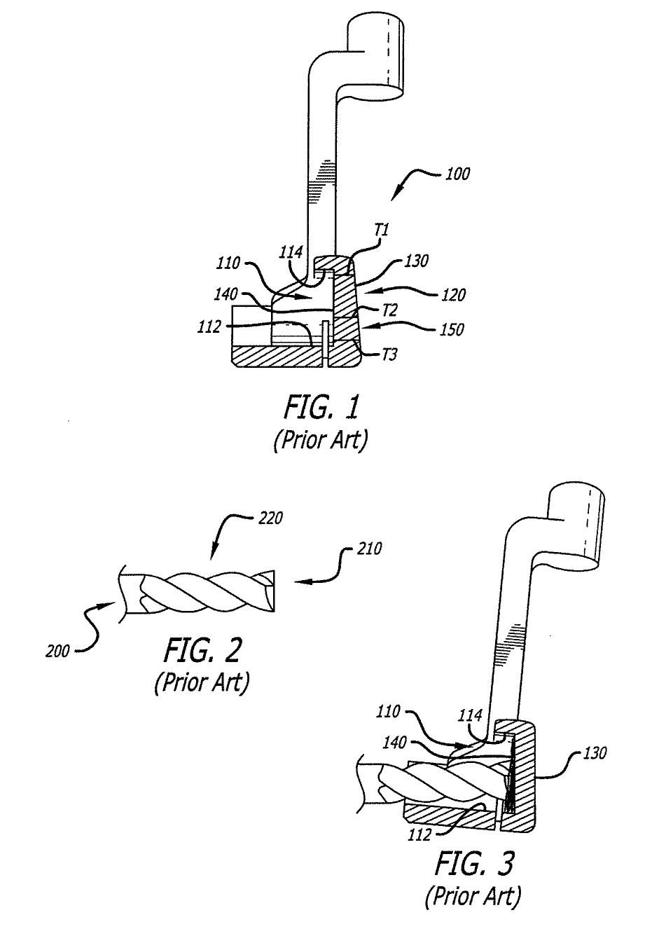

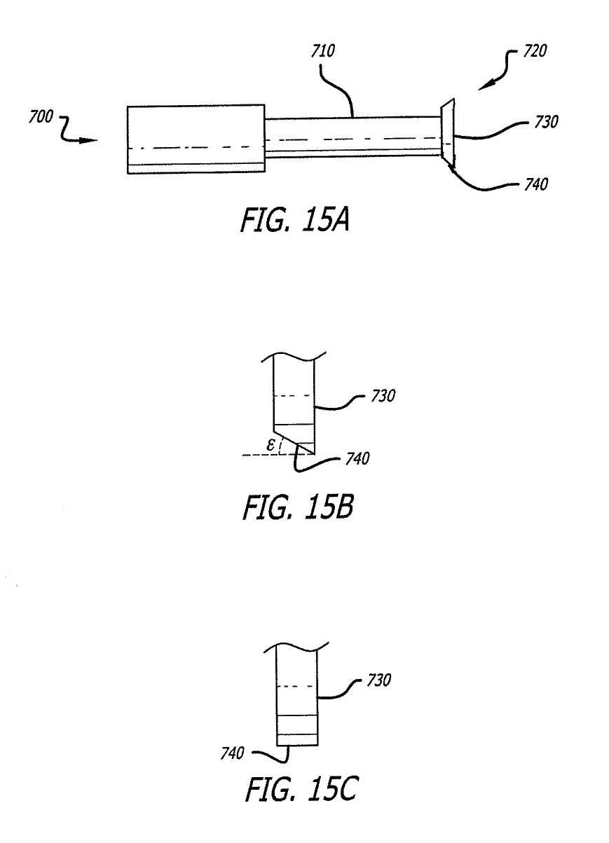

Referring to FIGS. 15A-15C, a second exemplary embodiment of an end mill 700 for post-processing putter heads is shown. Prior to processing, the putter head may be equivalent to a milled putter head 100 of FIG. 1 or may be a casting, a forging or a pre-machined forging of a putter head. End mill 700 comprises a shank 710 and a cutter 720. The outer diameter of shank 710 is configured to be less than an outer diameter of cutter 720 and the length of shank 710 exceeds the length of bottom flange 336 of FIGS. 5 and 9. This enables cutter 720 to access the corners of pocket 330 formed at the intersection of back wall 332 and top flange 335 or the intersection of back wall 332 and bottom flange 336, for example.

According to this embodiment of the invention, cutter 720 comprises a plurality of cutting surfaces including an end-cutting surface 730 and a side-cutting surface 740 positioned around the perimeter of end-cutting surface 730. According to one embodiment of the invention, as shown in FIG. 15B, side-cutting surface 740 is tapered with an angle (ε), which is an angle at least equal to or greater than the loft angle (θ) of striking surface of the putter head having a positive loft angle (e.g., ε≧θ). Regardless of whether the loft angle (θ) is a positive loft or a negative loft angle, the tapered angle (ε) of side-cutting surface 740 would still need to be equal to or greater than the absolute value of the loft angle (ε≧|θ|). This is necessary to properly access and remove material proximate to top flange 335 and back wall 332, for example.

According to another embodiment of the invention, cutter 720 may be adapted with side-cutting surface 740 that is generally perpendicular to end-cutting surface 730 as shown in FIG. 15C. While this type of cutter 720 for end mill 700 may be utilized, it is contemplated that a tapered side-cutting surface 740 may provide better control in formation of the pocket of the putter head.

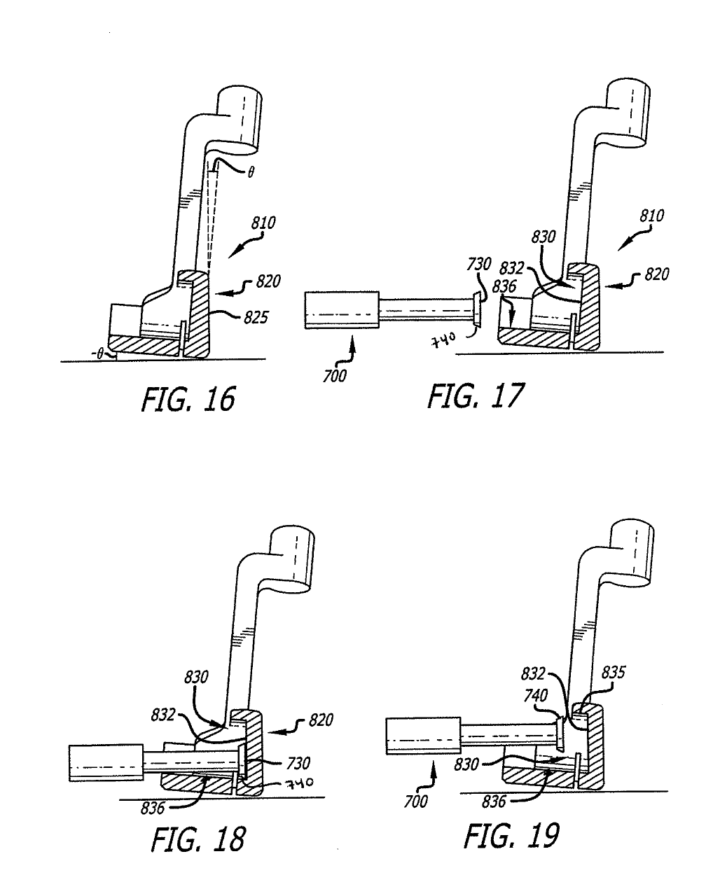

FIGS. 16-19 illustrate an exemplary embodiment of a process for post-processing a putter head 810, similar to putter head 310 shown in FIGS. 4 and 5, using end mill 700 of FIG. 15A. According to this embodiment of the invention, as shown in FIG. 16, putter head 810 is initially milled to create a face 820 having a non-uniform thickness and a striking surface 825 having a predetermined degree of loft (e.g., θ≈4°). Putter head 810 is rotated to square striking surface 825 so that, in this position, striking surface 825 has no loft. That is, the striking surface is substantially perpendicular to the ground, or a horizontal plane. More specifically, putter head 810 is rotated by an angle (−θ). According to this illustrative embodiment where striking surface 825 has positive loft (θ≈4°), putter head 810 would be negatively rotated by four degrees (−4°).

FIGS. 17 and 18 illustrate milling of putter head 810 using end mill 700. End mill 700 is positioned to move in a generally horizontal direction toward pocket 830. Upon insertion into pocket 830, end-cutting surface 730 cuts back wall 832 while side-cutting surface 740, tapered by angle ε as shown in FIG. 15B for example, accesses and removes any material adjacent to both back wall 832 and bottom flange 836 of pocket 830. The result of both cutting operations is to provide a vertically planar back wall 832 so that face 820 possesses a substantially uniform thickness.

Referring to FIG. 19, end mill 700 is moved upward to remove material adjacent to both back wall 832 and top flange 835 of pocket 830. Upon completion, end mill 700 is removed in a direction opposite the generally horizontal direction when inserted into pocket 830. As a result, tapered cutting side surface 740 may be adjusted to apply a horizontal cut to top flange 835 so that an inner surface of top flange 835 is substantially planar and in parallel with an interior surface of bottom flange 836.

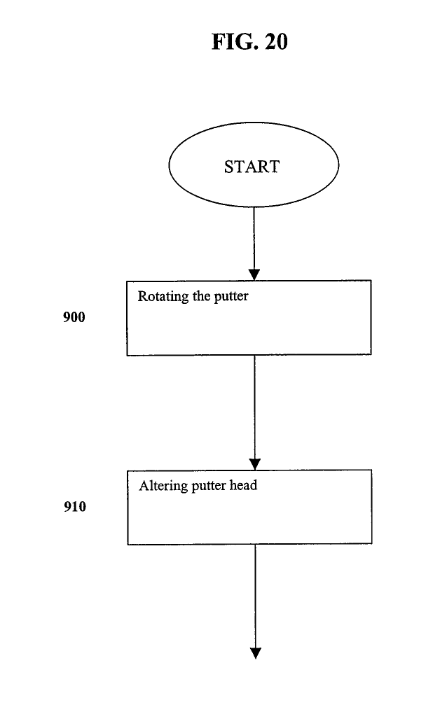

FIG. 20 is an exemplary embodiment of a flowchart illustrating the general process of manufacture of a putter head including a face of a substantially uniform thickness and a pocket having at least four surfaces protruding from the back wall as borders of the pocket. Initially, where the striking surface of the face features a predetermined degree of loft (θ), the putter head is rotated by an opposite angle (−θ) to square the striking surface (block 900). Thereafter, the back wall of the pocket is milled to render the back wall coplanar and substantially in parallel with the striking surface (block 910). This creates a face having both opposite surfaces with equivalently angles of loft so as to have substantially uniform thickness.

### E. Third Embodiment

### A Non-Homogenous Putter Head with Substantially Consistent Face Thickness

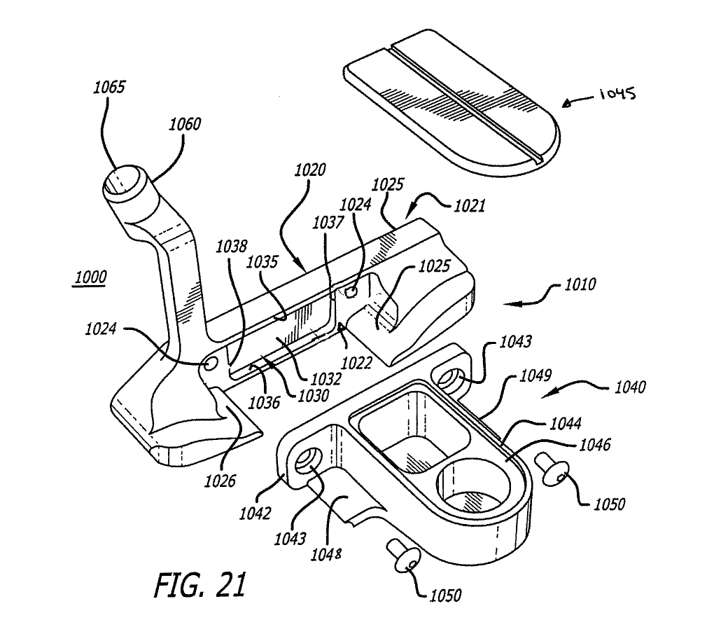

Referring to FIG. 21, an exploded view of a second exemplary embodiment of a putter 1000 is shown. Putter 1000 comprises a putter head 1010 and an optional elevated hosel 1060 extending upwardly and having an opening 1065 into which one end of a shaft (not shown) is inserted. Of course, it is contemplated that putter head 1010 may be adapted without hosel 1060, and alternatively would feature an opening into which the shaft is directly inserted.

According to one embodiment of the invention, putter head 1010 comprises a face 1020 that is generally formed from a single piece of material (e.g., metal or composition of metal). Face 1020 comprises a striking surface 1025 on a front face side 1021 and a recessed cavity (referred to as a “pocket”) 1030 formed on an opposite back side 1022 of face 1020.

Formed into back side 1022 of face 1020, pocket 1030 comprises a back wall 1032 bordered by at least four flange surfaces to form the recessed cavity. Back wall 1032 is sized with a surface area less than the surface area of back side 1022.

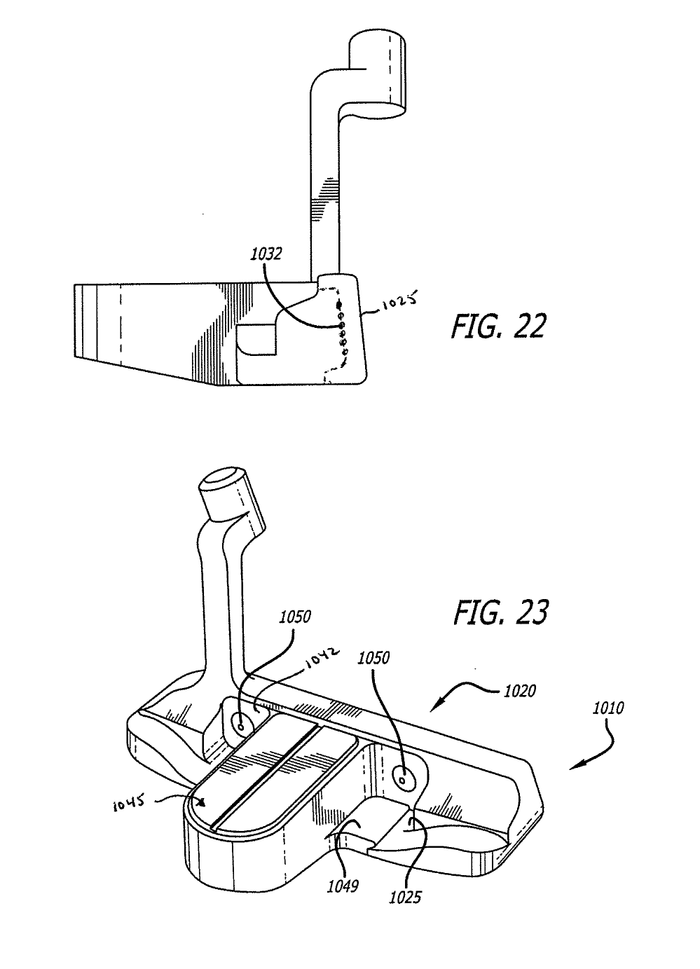

According to this embodiment of the invention, pocket 1030 features a top flange 1035, a bottom flange 1036 and side flanges 1037 and 1038 bordering and protruding from back wall 1032. As shown as dotted lines in FIG. 22, back wall 1032 is oriented substantially in parallel with striking surface 1025 so that the thickness between these two surfaces at any point is substantially consistent.

Referring back to FIG. 21, mounted over pocket 1030, a rear attachment member 1040 may be affixed to back side 1022 of face 1020 by fastening elements 1050. Rear attachment member 1040 includes a mounting plate 1042 formed with a protruding (e.g., U-shaped) extension 1044 having a plate (not shown) on a bottom edge to support an insert 1046. Insert 1046 is configured with a selected pattern in order to provide selected weighting to the back portion of putter head 1010. It is contemplated that the selected pattern for insert 1046 may be a static or perhaps dynamic where each insert can be individually modified for each golfer or a type of golfer (e.g., golfers who commonly leave putts short, commonly overshoot putts, miss to the right, etc.)

As an optional feature of the invention, it is contemplated that rear attachment member 1040 and insert 1046 are made of different materials and these materials differ from the materials used for face 1020, although such construction is not required to practice the invention. It is further contemplated that the plate may be made of the same material as face 1020.

Rear attachment member 1040 further includes a pair of support members 1048 and 1049 positioned on opposite sides of protruding extension 1044. Herein, mounting plate 1042 is sized for attachment to and covering of back side 1022. When mounting plate 1042 is attached to back side 1022, curved support members 1048 and 1049 rest upon support flanges 1025 and 1026 formed in putter head 1010, which extend from two edges of back side 1022 as shown in FIG. 23.

Referring to both FIGS. 21 and 23, according to one embodiment of the invention, fastening elements 1050 include cap rivets initially inserted through recessed mounting holes 1043 placed in mounting plate 1042. When mounting plate 1042 is placed adjacent to back side 1022, mounting holes 1043 are aligned with mounting holes 1024 of back side 1022. Rivets are affixed to mounting holes 1024. It is contemplated, however, that in lieu of rivets, other fastening elements such as screws, bolts, adhesives and the like may be used to attach mounting plate 1042 to back side 1022 of face 1020.

Configured with the same geometric shape as the aperture formed by protruding extension 1044, a cover 1045 is situated to cover insert 1046. Cover 1045 may be attached through a variety of attachment schemes, including an adhesive, high bond double-sided tapes or screws.

While certain exemplary embodiments have been described and shown in the accompanying drawings, it is to be understood that such embodiments are merely illustrative of and not restrictive on the broad invention, and that this invention not be limited to the specific construction, manufacture or arrangements shown and described, since various other modifications may occur to those ordinarily skilled in the art.

What is claimed is:

1. A method for manufacturing a putter head wherein the putter head includes a face with a striking surface that has a loft of a predetermined angle, and a pocket formed behind the face defined by a back wall on the opposite side of the face from the striking surface and positioned adjacent to the striking surface, the back wall extending in a first direction and a plurality of flanges extending from the back wall in a second direction, different from the first direction,
the method comprising:
providing the putter head with the back wall not parallel to the striking surface; and
altering the pocket of the putter head so that the back wall is substantially parallel to the striking surface.

2. The method of claim 1, wherein the altering step further comprises rotating the putter head by the predetermined angle such that the striking surface is substantially perpendicular to a horizontal plane.

3. The method of claim 2, wherein the altering step further comprises milling the pocket with an end mill, wherein the end mill is moved to contact and mill the back wall of the putter head.

4. The method of claim 1, wherein the altering step further comprises: milling the pocket so that a thickness of the face between the striking surface and the back wall is substantially uniform.

5. The method of claim 4, wherein the flange include a bottom flange and the altering step further comprises: milling the back wall of the pocket so that an angle is formed between the back wall and the bottom flange which is complementary to the predetermined angle and ranges between 85 degrees and 89.5 degrees.

6. The method of claim 5, wherein the flanges also include a top flange, and the altering step further comprises milling the back wall of the pocket so that an interior angle is formed between the back wall and the top flange, is an obtuse angle ranging between 90.5 degrees and 95 degrees.

7. The method of claim 3, wherein the end mill further comprises:
a cutter positioned at the cutting end of the end mill; and
a shank connected to the cutter on an end opposite the cutting end, wherein an outer diameter of the cutter is greater than that of the shank and wherein the cutter includes a plurality of cutting surfaces including an end cutting surface and a side cutting surface positioned around a perimeter of the end cutting surface wherein the side cutting surface is tapered at an angle at least equal to the predetermined angle.

8. The method of claim 1, wherein the pocket is altered by milling the back face through computer numeric controlled milling, hand milling, or electrical discharge milling.
